(19) United States
(12) Patent Application Publication
(10) Pub. No.: US 2026/0258952 A1
(43) Pub. Date: Sep. 3, 2026

(54) COMBUSTOR AND GAS TURBINE

(71) Applicant: MITSUBISHI HEAVY INDUSTRIES, LTD., Tokyo (JP)

(72) Inventors: Kenjiro KOMATSU, Tokyo (JP); Hiromi KOIZUMI, Tokyo (JP); Yoshitaka HIRATA, Tokyo (JP); Keisuke MIURA, Tokyo (JP); Yoshinori MATSUBARA, Tokyo (JP)

(21) Appl. No.: 19/491,224

(22) PCT Filed: Jun. 6, 2024
(86) PCT No.: PCT/JP2024/020763

§ 371 Date: Dec. 8, 2025

(30) Foreign Application Priority Data
Jun. 15, 2023 (JP) 2023-098806

(51) Int. Cl. F23R 3/28; F02C 9/32; F23R 3/12

(52) U.S. Cl. CPC F23R 3/286; F02C 9/32; F23R 3/12

(57) ABSTRACT

A combustor includes a central burner and an outer burner. The outer burner includes: an inner burner surrounding an outer axis located on the radial outer-side of a demarcated combustor axis; and an outer burner surrounding the demarcated inner burner. The amount of fuel supplied to demarcated fuel nozzles can be independently adjusted for the demarcated inner burner and the demarcated outer burner. A hole-free region where demarcated air holes of the outer burner are not formed is provided between the inner burner and the demarcated central burner on the downstream end face.

### TECHNICAL FIELD

The present disclosure relates to a combustor and a gas turbine.

The present application claims priority with respect to Japanese Patent Application No. 2023-098806 filed in Japan on Jun. 15, 2023, the contents of which are incorporated herein by reference.

### BACKGROUND ART

For example, PTL 1 discloses a multi-cluster combustor as an example of a combustor used in a gas turbine.

The multi-cluster combustor includes an air hole plate that is formed with a plurality of air holes, and a fuel nozzle that supplies fuel to each of the air holes. A central burner is formed by the air holes that are collectively disposed in a central portion of the air hole plate. An outer-side burner is formed by the air holes that are collectively disposed in an outer peripheral portion of the air hole plate. A plurality of outer-side burners are arranged in a circumferential direction to surround the central burner. The outer burner is configured of an inner burner and an outer burner, each of which has an independent fuel supply system.

### CITATION LIST

### Patent Literature

[PTL 1] Japanese Unexamined Patent Application Publication No. 2013-155626

### SUMMARY OF INVENTION

### Technical Problem

Meanwhile, the combustor as described above desirably realizes further low NOx emission while enabling a stable operation in which combustion oscillation is suppressed.

The present disclosure has been made to solve the above problem, and an object of the present disclosure is to provide a combustor and a gas turbine capable of achieving low NOx emission while performing a stable operation.

### Solution to Problem

In order to solve the above-described problems, according to the present disclosure, there is provided a combustor including an air hole plate that has a plurality of air holes extending in a direction of a combustor axis line and opening to a downstream end surface, and a plurality of fuel nozzles that are provided to correspond to the respective air holes and each supply fuel to the corresponding air hole from an upstream side, in which a central burner is configured of the plurality of air holes and the plurality of fuel nozzles that are collectively disposed to surround the combustor axis line, an outer-side burner is configured of the plurality of air holes and the plurality of fuel nozzles that are collectively disposed on a radial outer side of the central burner, the outer-side burner includes an inner burner that is provided to surround an outer-side axis line located on a radial outer side of the combustor axis line, and an outer burner that is provided to surround the inner burner, a fuel supply amount to the fuel nozzle is independently adjustable for the inner burner and the outer burner, and a hole non-forming region in which the air holes of the outer burner are not formed is provided between the inner burner and the central burner on the downstream end surface.

According to the present disclosure, there is provided a gas turbine including the combustor described above, a compressor that compresses air and supplies the compressed air to the combustor, a turbine that is driven by combustion gas generated by the combustor, and a fuel control device that controls a fuel supply amount to the fuel nozzle of the combustor, in which the fuel control device sets the fuel supply amount such that, at a rated load, a fuel-air ratio of the central burner is higher than a fuel-air ratio of the outer burner and a fuel-air ratio of the inner burner is higher than the fuel-air ratio of the outer burner.

### Advantageous Effects of Invention

With the combustor and the gas turbine of the present disclosure, it is possible to achieve low NOx emission while performing the stable operation.

### BRIEF DESCRIPTION OF DRAWINGS

FIG. 1 is a schematic view of a schematic configuration of a gas turbine according to a first embodiment of the present disclosure.

FIG. 2 is a vertical sectional view of a schematic configuration of a combustor according to the first embodiment of the present disclosure.

FIG. 3 is a view, as viewed from a downstream side, of the combustor according to the first embodiment of the present disclosure.

FIG. 4 is an enlarged view of main parts of FIG. 3.

FIG. 5 is a functional block diagram of a fuel control device of the gas turbine according to the first embodiment of the present disclosure.

FIG. 6 is a flowchart showing a processing flow of the fuel control device in the gas turbine according to the first embodiment of the present disclosure.

FIG. 7 is an enlarged view, as viewed from a downstream side, of main parts of the combustor according to a second embodiment of the present disclosure.

FIG. 8 is a hardware configuration diagram of the fuel control device of the gas turbine according to the present disclosure.

### DESCRIPTION OF EMBODIMENTS

### First Embodiment

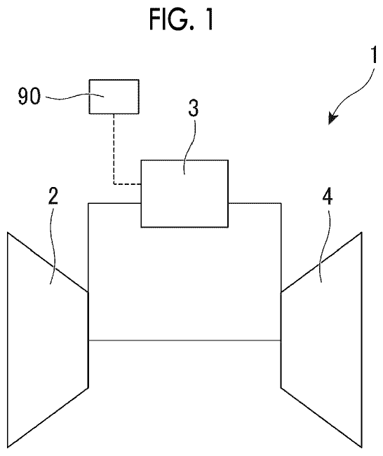

Hereinafter, a first embodiment of the present invention will be described in detail with reference to FIGS. 1 to 6.

As shown in FIG. 1, a gas turbine 1 according to the present embodiment includes a compressor 2 that compresses air, a combustor 3 that generates combustion gas, a turbine 4 that is driven by the combustion gas, and a fuel control device 90 that controls a fuel supply amount to the combustor 3.

A plurality of combustors 3 are provided at spacings in a circumferential direction around a rotary shaft of the gas turbine 1. The combustor 3 mixes fuel with the air compressed by the compressor 2 and combusts the mixture to generate the high-temperature and high-pressure combustion gas.

### Combustor

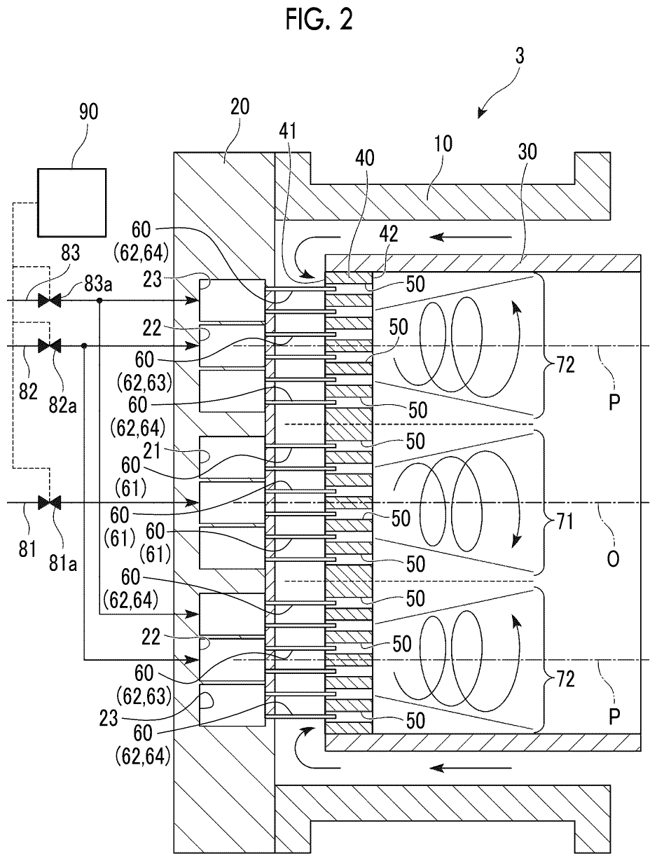

Hereinafter, a configuration of the combustor 3 will be described with reference to FIGS. 2 to 4.

As shown in FIG. 2, the combustor 3 includes an outer cylinder 10, an end cover 20, an inner cylinder 30, an air hole plate 40, a fuel nozzle 60, and a fuel supply system 80.

### Outer Cylinder

The outer cylinder 10 has a cylindrical shape centered on a combustor axis line O (hereinafter, simply referred to as axis line O), which is the combustor axis line O serving as a center of the combustor 3. The combustion gas is generated in a space on an inner side of the outer cylinder 10. The combustion gas flows from one side in an axis line O direction (left side in FIG. 2) serving as an upstream side toward the other side in the axis line O direction (right side in FIG. 2) serving as a downstream side.

### End Cover

The end cover 20 is a disk-shaped member that closes an end portion of the outer cylinder 10 on the upstream side. The end portion of the outer cylinder 10 on the upstream side abuts on the end cover 20.

A first fuel header 21, a second fuel header 22, and a third fuel header 23 are formed, as spaces, inside the end cover 20. The fuel is supplied from the outside to the first fuel header 21, the second fuel header 22, and the third fuel header 23.

The first fuel header 21 is the space formed along the axis line O.

The second fuel header 22 is the space formed along an outer-side axis line P, which is separated from the axis line O on a radial outer side of the axis line O. A plurality of (six in the present embodiment) outer-side axis lines P are disposed to be separated in the circumferential direction of the axis line O, as shown in FIG. 2.

The third fuel header 23 is the space formed to surround each second fuel header 22 from a radial outer side of the outer-side axis line P. The third fuel header 23 has an annular shape formed concentrically with the second fuel header 22.

### Inner Cylinder

The inner cylinder 30 is a cylindrical member centered on the axis line O, and is disposed coaxially with the outer cylinder 10 on the inner side of the outer cylinder 10. An end portion of the inner cylinder 30 on the upstream side is separated from the end cover 20 in the axis line O direction. An outer diameter of the inner cylinder 30 is smaller than an outer diameter of the inner cylinder 30. The inner cylinder 30 is provided, by a support (not shown), on the inner side of the outer cylinder 10 at spacings from the outer cylinder 10 and the end cover 20. Accordingly, an annular flow path is formed between an outer peripheral surface of the inner cylinder 30 and an inner peripheral surface of the outer cylinder 10. The air compressed by the compressor 2 flows through the flow path from the other side in the axis line O direction toward the one side in the axis line O direction.

### Air Hole Plate

The air hole plate 40 has a disk shape centered on the axis line O. The air hole plate 40 is provided on an inner side of the inner cylinder 30 to be fitted coaxially with the inner cylinder 30. The air hole plate 40 is fitted to the end portion of the inner cylinder 30 on the upstream side. The air hole plate 40 has an upstream end surface 41 and a downstream end surface 42.

### Upstream End Surface

The upstream end surface 41 is an end surface of the air hole plate 40 on the upstream side, and has a planar shape orthogonal to the axis line O. The upstream end surface 41 is disposed at the same position in the axis line O direction as an end surface of the inner cylinder 30 on the upstream side.

### Downstream End Surface

The downstream end surface 42 is an end surface of the air hole plate 40 on the downstream side, and has a planar shape orthogonal to the axis line O. The downstream end surface 42 is located on the downstream side with respect to an end surface of the inner cylinder 30 on the upstream side. Accordingly, the space is formed in a partitioned manner by an inner peripheral surface of the inner cylinder 30 and the downstream end surface 42 of the air hole plate 40. The space is a combustion space of the combustor 3.

### Air Hole

The air hole plate 40 is formed with a plurality of air holes 50 that penetrate through the upstream end surface 41 and the downstream end surface 42. The air hole plate 40 extends in the axis line O direction. The air holes 50 are open in each of the upstream end surface 41 and the downstream end surface 42. The air is configured to flow in through an opening of the upstream end surface 41 of each air hole 50, and the air is configured to flow out through an opening of the downstream end surface 42 of each air hole 50.

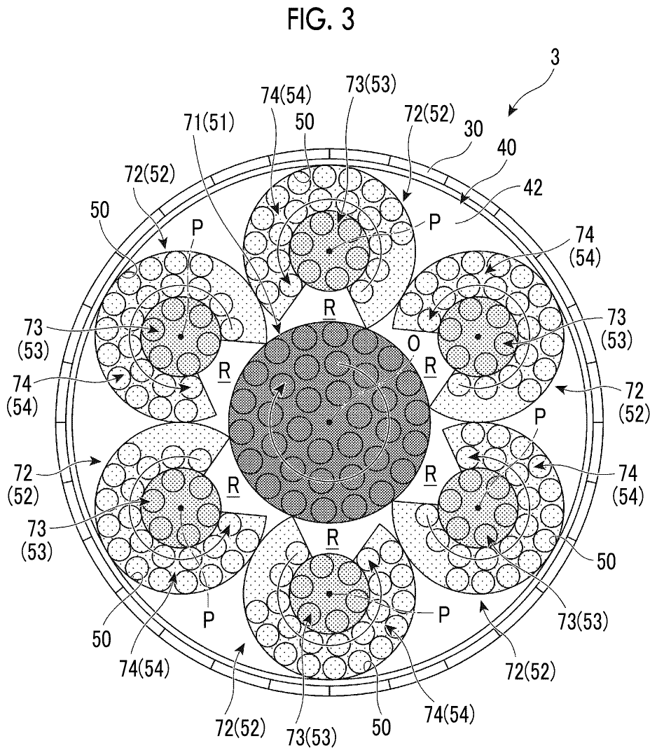

As shown in detail in FIG. 3, the air holes 50 are collectively disposed to form an air hole group. The air hole group includes a central air hole group 51 and an outer-side air hole group 52.

### Central Air Hole Group

The central air hole group 51 is formed at a central portion of the air hole plate 40 as viewed in the axis line O direction. That is, the central air hole group 51 is formed of the air holes 50 that are collectively disposed in a circular region centered on the axis line O to surround the axis line O of the air hole plate 40.

A plurality of rows (three rows in the present embodiment) of hole rows, which are composed of the plurality of air holes 50 arranged in an annular shape centered on the axis line O, are disposed in the radial direction to configure the central air hole group 51.

The air holes 50 configuring the central air hole group 51 each extend to swirl in the circumferential direction of the axis line O from the upstream side toward the downstream side. That is, these air holes 50 are configured to have a swirling angle with respect to the axis line O.

### Outer-Side Air Hole Group

A plurality of outer-side air hole groups 52 are formed at spacings in the circumferential direction of the axis line O to surround the central portion of the air hole plate 40 as viewed in the axis line O direction. The outer-side air hole group 52 is formed on the radial outer side of the axis line O in the central portion and on a radial inner side of an outer peripheral edge of the air hole plate 40. The outer-side air hole group 52 is formed by the air holes 50 that are each collectively disposed in a circular region centered on the outer-side axis line P to surround the outer-side axis line P.

The outer-side air hole group 52 is configured of an inner-peripheral air hole group 53 and an outer-peripheral air hole group 54.

The inner-peripheral air hole group 53 is formed by hole rows, which are arranged in an annular shape centered on the outer-side axis line P to surround the outer-side axis line P. The inner-peripheral air hole group 53 of the present embodiment is configured by one annular hole row in one circumference.

The outer-peripheral air hole group 54 is provided to surround the inner-peripheral air hole group 53 from the radial outer side of the outer-side axis line P. The outer-peripheral air hole group 54 has a hole row, which is composed of the plurality of air holes 50 arranged in the circumferential direction of the outer-side axis line P. A plurality of rows (two rows in the present embodiment) of hole rows are disposed in the radial direction to configure the outer-peripheral air hole group 54 of the present embodiment.

The air holes 50 configuring the outer-side air hole group 52 each extend to swirl in the circumferential direction of the outer-side axis line P from the upstream side toward the downstream side. That is, these air holes 50 are configured to have a swirling angle with respect to the outer-side axis line P.

A swirling direction of the air holes 50 configuring the outer-side air hole group 52 is a direction opposite to the swirling direction of the air holes 50 configuring the central air hole group 51. In the present embodiment, as viewed from the downstream side, the air holes 50 configuring the central air hole group 51 extend in a clockwise direction (first swirling direction) toward the downstream side, while the air holes 50 configuring the outer-side air hole group 52 extend in a counterclockwise direction (second swirling direction) toward the downstream side.

### Fuel Nozzle

As shown in FIG. 2, a plurality of fuel nozzles 60 are provided to correspond one-to-one to respective air holes 50. The fuel nozzle 60 ejects the fuel into each of the air holes 50. The fuel supplied from the fuel nozzle 60 into the air hole 50 is mixed with the air flowing through the air hole 50 to generate a premixed gas.

Each fuel nozzle 60 has a tubular shape extending parallel to the axis line O. A fuel injection hole for supplying the fuel is formed at a tip, which is an end portion of the fuel nozzle 60 on a downstream side. The tip of the fuel nozzle 60 is inserted into a corresponding air hole 50 from the opening of the upstream end surface 41. The plurality of fuel nozzles 60 are disposed to be separated in a direction orthogonal to the axis line O in accordance with the disposition of the air holes 50.

A base end on a side opposite to the tip of the fuel nozzle 60 is fixed to the end cover 20. A fuel inlet port is formed at the base end of the fuel nozzle 60. The fuel inlet port of each fuel nozzle 60 communicates with any one of the first fuel header 21, the second fuel header 22, and the third fuel header 23.

The fuel nozzles 60 that supply the fuel to the air holes 50 configuring the central air hole group 51 are central nozzles 61. The central nozzles 61 are collectively disposed to surround the axis line O corresponding to the central air hole group 51. A base end of the central nozzle 61 is connected to the first fuel header 21. Accordingly, the fuel is supplied to the central nozzle 61 via the first fuel header 21.

The fuel nozzles 60 that supply the fuel to the air holes 50 configuring the outer-side air hole group 52 are outer-side nozzles 62. The outer-side nozzles 62 are collectively disposed to surround the outer-side axis line P corresponding to the outer-side air hole group 52. The outer-side nozzles 62 each include a plurality of inner-peripheral nozzles 63 and a plurality of outer-peripheral nozzles 64.

The inner-peripheral nozzles 63 supply the fuel to the air holes 50 configuring the inner-peripheral air hole group 53 of the outer-side air hole group 52. The inner-peripheral nozzle 63 is provided in a region of the outer-side air hole group 52 on a radial inner side of the outer-side axis line P, in correspondence with the inner-peripheral air hole group 53. A base end of the inner-peripheral nozzle 63 is connected to the second fuel header 22. Accordingly, the fuel is supplied to the inner-peripheral nozzle 63 via the second fuel header 22.

The outer-peripheral nozzles 64 supply the fuel to the air holes 50 configuring the outer-peripheral air hole group 54 of the outer-side air hole group 52. The outer-peripheral nozzle 64 is provided in a region on the radial outer side of the outer-side axis line P in the outer-side air hole group 52, in correspondence with the outer-peripheral air hole group 54. A base end of the outer-peripheral nozzle 64 is connected to the third fuel header 23. Accordingly, the fuel is supplied to the outer-peripheral nozzle 64 via the third fuel header 23.

### Fuel Supply System

As shown in FIG. 1, the fuel supply system 80 is a system that supplies the fuel to each fuel nozzle 60 via the first fuel header 21, the second fuel header 22, and the third fuel header 23. In the present embodiment, it is possible to independently adjust the fuel supply amount supplied to each of the first fuel header 21, the second fuel header 22, and the third fuel header 23. Accordingly, it is possible to individually adjust the fuel supply amount to each of the central nozzle 61 connected to the first fuel header 21, the inner-peripheral nozzle 63 connected to the second fuel header 22, and the outer-peripheral nozzle 64 connected to the third fuel header 23.

The fuel supply system 80 includes a first fuel line 81, a first fuel regulating valve 81a, a second fuel line 82, a second fuel regulating valve 82a, a third fuel line 83, and a third fuel regulating valve 83a.

The first fuel line 81, the second fuel line 82, and the third fuel line 83 are each connected to a fuel tank. An example of the fuel supplied from the fuel tank includes natural gas. Hydrogen, a mixed fuel of hydrogen and natural gas, or other fuels may be employed.

The first fuel line 81 is connected to the first fuel header 21. The first fuel line 81 is provided with the first fuel regulating valve 81a.

The second fuel line 82 is branched in the middle, and connected to each second fuel header 22. The second fuel line 82 is provided with the second fuel regulating valve 82a.

The third fuel line 83 is branched in the middle, and connected to each third fuel header 23. The third fuel line 83 is provided with the third fuel regulating valve 83a.

### Each Burner and Details Thereof

The plurality of central nozzles 61, which supply the fuel to the central air hole group 51 and the air holes 50 configuring the central air hole group 51, configure a central burner 71.

The plurality of outer-side nozzles 62, which supply the fuel to the outer-side air hole group 52 and the air holes 50 configuring the outer-side air hole group 52, configure the central burner 71.

A portion of the outer-side burner 72 on the radial inner side of the outer-side axis line P is an inner burner 73 that surrounds the outer-side axis line P.

A portion of the outer-side burner 72 on the radial outer side of the outer-side axis line P is an outer burner 74 that covers the inner burner 73 from an outer-peripheral side of the outer-side axis line P.

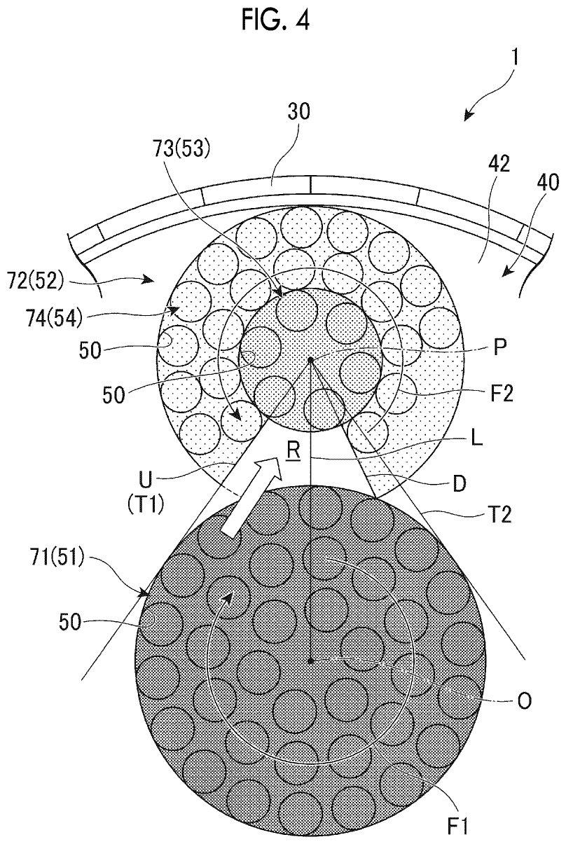

Details of each burner will be described with reference to FIG. 4.

Since the air holes 50 configuring the central air hole group 51 of the central burner 71 have the swirling angle in the first swirling direction, the premixed gas from the central air hole group 51 is ejected to the radial outer side of the axis line O while swirling in the first swirling direction. With ignition of the premixed gas, flame having a central swirling flow F1 around the axis line O is formed.

Since the air holes 50 configuring the outer-side air hole group 52 of the outer-side burner 72 have the swirling angle in the second swirling direction opposite to the first swirling direction, the premixed gas from the central air hole group 51 swirls in the second swirling direction opposite to the first swirling direction and is ejected to the radial outer side of the outer-side axis line P. With ignition of the premixed gas, flame having an outer-side swirling flow F2 around the outer-side axis line P and in a direction opposite to the central swirling flow F1 is formed.

In a case where the downstream end surface 42 is viewed from the downstream side, a region where the air holes 50 of the outer-peripheral air hole group 54 configuring the outer burner 74 are not formed is present between the central air hole group 51 configuring the central burner 71 and the inner-peripheral air hole group 53 configuring the inner burner 73. The region is a hole non-forming region R. The air holes 50 are not open in the hole non-forming region R, and only a plane of the downstream end surface 42 without the air holes 50 is present between the central air hole group 51 and the inner-peripheral air hole group 53.

The outer-peripheral air hole group 54 is provided only over a part of the outer-side axis line P in the circumferential direction. That is, the outer-peripheral air hole group 54 is present only in a portion deviated from the hole non-forming region R between the central air hole group 51 and the inner-peripheral air hole group 53. In other words, the outer-peripheral air hole group 54 is present only in a remaining region of which a part in the circumferential direction is cut out by the hole non-forming region R.

In the present embodiment, the hole row of the outer-peripheral air hole group 54 extending in the circumferential direction at an innermost periphery is present in the region in the circumferential direction excluding only the hole non-forming region R. Further, the hole row of the outer-peripheral air hole group 54 extending in the circumferential direction at an outermost periphery is provided in a circumferential range narrower than a circumferential range of an innermost peripheral hole row. An outermost peripheral hole row may be provided in the same circumferential range as the innermost peripheral hole row.

As shown in FIG. 4, in a case where the downstream end surface 42 is viewed from the downstream side, a straight line connecting the axis line O and the outer-side axis line P is a reference line L. The reference line L is a straight line extending in the radial direction of the axis line O and the outer-side axis line P. The hole non-forming region R spreads, with the outer-side axis line P as a center, to a predetermined range from the reference line L toward an upstream side of the outer-side swirling flow F2. Further, in the present embodiment, the hole non-forming region R spreads, with the outer-side axis line P as a center, to a predetermined range from the reference line L toward a downstream side of the outer-side swirling flow F2.

As shown in FIG. 4, in a case where the downstream end surface 42 is viewed from the downstream side, a straight line defining an end portion of the outer-side swirling flow F2 on the upstream side in the hole non-forming region R, among straight lines extending from the outer-side axis line P in the radial direction of the outer-side axis line P, is referred to as an upstream-side boundary line U. Further, in a case where the downstream end surface 42 is viewed from the downstream side, a straight line defining an end portion of the outer-side swirling flow F2 on the downstream side in the hole non-forming region R, among the straight lines extending from the outer-side axis line P in the radial direction of the outer-side axis line P, is referred to as the upstream-side boundary line U. The hole non-forming region R is present over the upstream-side boundary line U and the downstream-side boundary line D in the region around the outer-side axis line P.

The upstream-side boundary line U of the present embodiment is located in a range from the reference line L to an upstream tangential line T1 in a circumferential region centered on the outer-side axis line P. More specifically, the upstream-side boundary line U is located in a range on the upstream side of the outer-side swirling flow F2 with respect to the reference line L and in a range up to the upstream tangential line T1.

The upstream tangential line T1 is located on the upstream side of the outer-side swirling flow F2 as viewed from a radial inner side of the axis line O, among two tangential lines drawn to a circle defining an outer edge of the central burner 71 from the outer-side axis line P. The air hole 50 at one end portion of the outer-peripheral air hole group 54 of the outer burner 74 in the circumferential direction is in contact with the upstream tangential line T1 from the upstream side of the outer-side swirling flow F2.

Further, the circle defining the outer edge of the central burner 71 is a virtual circle centered on an axis line on which the air holes 50 in one outermost peripheral row of the central air hole group 51 in the central burner 71 are inscribed. All of the air holes 50 in the one outermost peripheral row of the central air hole group 51 are not necessarily to be inscribed in the circle, and only a part of the air holes 50 may be inscribed in the circle. In the present embodiment, the upstream-side boundary line U matches the upstream tangential line T1.

The downstream-side boundary line D of the present embodiment is located in a range from the reference line L to a downstream tangential line T2 in the circumferential region centered on the outer-side axis line P. More specifically, the downstream-side boundary line D is located in a range on the downstream side of the outer-side swirling flow F2 with respect to the reference line L and in a range up to the downstream tangential line T2.

The downstream tangential line T2 is located on the downstream side of the outer-side swirling flow F2 as viewed from the radial inner side of the axis line O, among the two tangential lines drawn to the circle defining the outer edge of the central burner 71 from the outer-side axis line P. The air hole 50 at the other end portion of the outer-peripheral air hole group 54 of the outer burner 74 in the circumferential direction is in contact with the downstream tangential line T2 from the downstream side of the outer-side swirling flow F2.

In the present embodiment, the downstream-side boundary line D is located at a position close to the downstream tangential line T2 in a region between the reference line L and the downstream tangential line T2.

Therefore, the hole non-forming region R of the present embodiment is disposed on the upstream side of the outer-side swirling flow F2 in the swirling direction with reference to the reference line L, in a region between the central burner 71 and the inner burner 73. That is, in the hole non-forming region R, the region of the outer-side swirling flow F2 on the upstream side with respect to the reference line L is wider than the region of the outer-side swirling flow F2 on the downstream side with respect to the reference line L.

An angle formed by the upstream-side boundary line U and the downstream-side boundary line D is set in a range of, for example, 30° to 90°, preferably 45° to 75°, and more preferably 55° to 65°.

### Fuel Control Device

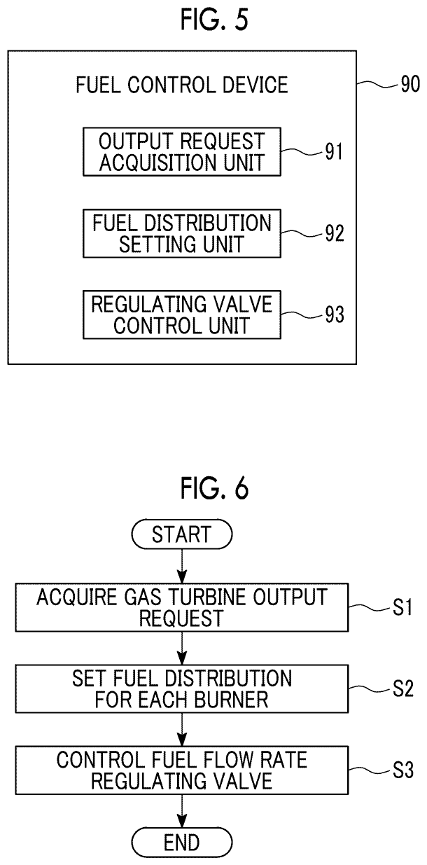

Next, the fuel control device 90 will be described with reference to FIGS. 5 and 6. The fuel control device 90 controls the fuel supply amount to each burner. The fuel control device 90 includes an output request acquisition unit 91, a fuel distribution setting unit 92, and a regulating valve control unit 93, as shown in FIG. 5.

The output request acquisition unit 91 acquires an output request signal of the gas turbine 1. The fuel distribution setting unit 92 sets opening degrees of the first fuel regulating valve 81a, the second fuel regulating valve 82a, and the third fuel regulating valve 83a in accordance with the output request signal acquired by the output request acquisition unit 91. The regulating valve control unit 93 controls the first fuel regulating valve 81a, the second fuel regulating valve 82a, and the third fuel regulating valve 83a such that the above valves have the opening degrees set by the fuel distribution setting unit 92.

Next, a procedure of processing of the fuel control device 90 will be described with reference to a flowchart shown in FIG. 5. First, the output request acquisition unit 91 acquires the output request signal of the gas turbine 1 (step S1).

Subsequently, the fuel distribution setting unit 92 sets the opening degrees of the first fuel regulating valve 81a, the second fuel regulating valve 82a, and the third fuel regulating valve 83a such that a fuel-air ratio (dimensionless number obtained by dividing fuel mass by air mass) of each fuel nozzle 60 is an appropriate value in accordance with a difference between the output request signal and an actual output of the gas turbine 1 (step S2). For example, in a case where an output request of the gas turbine 1 is a rated operation (full load operation), the fuel-air ratio of each fuel nozzle 60 is set such that the central nozzle 61 is larger than the inner-peripheral nozzle 63 and the inner-peripheral nozzle 63 is larger than the outer-peripheral nozzle 64. The fuel distribution setting unit 92 sets the opening degrees of the first fuel regulating valve 81a, the second fuel regulating valve 82a, and the third fuel regulating valve 83a to achieve the fuel-air ratio.

The regulating valve control unit 93 controls the first fuel regulating valve 81a, the second fuel regulating valve 82a, and the third fuel regulating valve 83a based on the set opening degrees (step S3). Accordingly, the fuel is supplied to the first fuel header 21, the second fuel header 22, and the third fuel header 23 to achieve the fuel-air ratio in accordance with the output request of the gas turbine 1. Accordingly, it is possible to operate the gas turbine 1 in accordance with the output request.

### Action Effect

In the combustor 3 of the gas turbine 1 during operation, the central burner 71 having a highest fuel-air ratio during the rated operation plays a role in maintaining the frame of the outer burner 74. Further, in each outer burner 74, the inner burner 73 having a relatively high fuel-air ratio maintains the flame of the outer burner 74 having a relatively low fuel-air ratio.

In the present embodiment, as shown in FIG. 4, the hole non-forming region R in which the air holes 50 configuring the outer-peripheral air hole group 54 of the outer burner 74 are not present is provided between the central burner 71 and the inner burner 73. Therefore, it is possible to guide the flame, which is generated in the combustion space by the central burner 71, to the inner burner 73 via the hole non-forming region R.

In a case where the air holes 50 of the outer burner 74 are present in the entire circumferential direction of the outer-side axis line P, the entire circumference of the inner burner 73 is covered with the flame from the outer burner 74 having the outer-side swirling flow F2. For this reason, the flame of the outer burner 74 serves as a barrier, and thus it is difficult to cause the flame of the central burner 71 to reach the inner burner 73.

On the contrary, in the present embodiment, since the air holes 50 of the outer burner 74 are not present in the region between the central burner 71 and the inner burner 73, a region without the flame of the outer burner 74 is formed between the central burner 71 and the inner burner 73. Therefore, the flame of the central burner 71 can reach the inner burner 73 without being blocked by the flame of the outer burner 74.

Accordingly, it is possible to improve flame transferability from the central burner 71 to the inner burner 73. As a result, the flame of the central burner 71 can assist the combustion of the flame of the inner burner 73, and thus it is possible to improve flame maintainability of the inner burner 73. Further, with the improvement of the flame maintainability of the inner burner 73, it is also possible to improve combustibility of the outer burner 74 whose flame is maintained by the inner burner 73. Therefore, it is possible to improve the combustibility of the combustor 3 as a whole, and thus to perform a stable operation in which combustion oscillation is suppressed.

With the improvement of the flame transferability from the central burner 71 to the inner burner 73, it is possible to stably maintain the flame of the inner burner 73 even in a case where the fuel supply amount to the inner burner 73 is reduced from a previous amount to reduce the fuel-air ratio. Therefore, it is possible to lower a temperature of the flame generated from the inner burner 73, and as a result, it is possible to suppress the generation of NOx.

Further, with the provision of the hole non-forming region R, an air flow rate of the central air hole group 51 of the central burner 71 and an air flow rate of the inner-peripheral air hole group 53 of the inner burner 73 increase by a reduced number of the air holes 50 of the air hole group configuring the outer burner 74. Therefore, it is possible to lower flame temperatures of the central burner 71 and the inner burner 73 whose flame temperatures are high. As a result, it is possible to reduce a total amount of NOx generated in the combustor 3 as a whole.

In the present embodiment, the hole non-forming region R spreads to the upstream side of the outer-side swirling flow F2 with respect to the reference line L. Thus, the hole non-forming region R is configured to be open in a tangential direction of the central swirling flow F1 of the central burner 71. Therefore, it is possible to smoothly guide the flame of the central burner 71 to the inner burner 73 along the flow of the central swirling flow F1, and thus to improve the flame maintainability of the inner burner 73.

Further, in the present embodiment, the upstream-side boundary line U of the hole non-forming region R matches the tangential line of the circle configuring the outer edge of the central burner 71. Accordingly, the flame guided along the flow of the central swirling flow F1 can be maximally taken into the inner burner 73. Therefore, it is possible to further improve the flame maintainability of the inner burner 73.

Further, since the hole non-forming region R also spreads to the downstream side of the outer-side swirling flow F2 with respect to the reference line L, an inlet port of the flame of the central burner 71 to the inner burner 73 can be made large from the upstream side to the downstream side. Accordingly, it is possible to perform the flame movement from the central burner 71 to the inner burner 73 more reliably.

Further, in the hole non-forming region R, the region of the outer-side swirling flow F2 on the upstream side with respect to the reference line L is wider than the region of the outer-side swirling flow F2 on the downstream side with respect to the reference line L. Therefore, it is possible to ensure a large formation region of the outer burner 74 of the outer-side burner 72 while improving the flame transferability of the flame from the central burner 71 to the inner burner 73. As a result, it is possible to ensure the output of the combustor 3.

### Second Embodiment

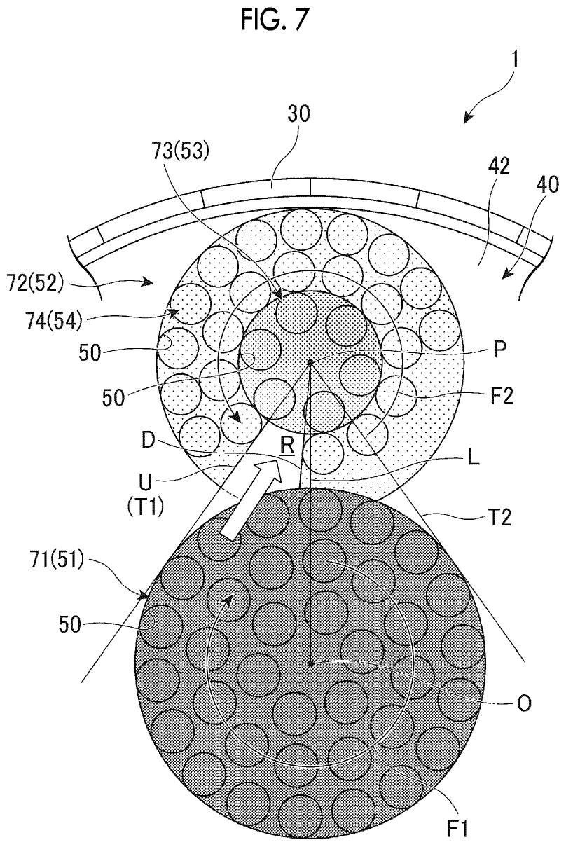

Next, the combustor 3 according to a second embodiment will be described with reference to FIG. 7. In the second embodiment, the same reference numerals will be assigned to configuration elements which are the same as those according to the first embodiment, and a detailed description thereof will be omitted.

The combustor 3 of the second embodiment is different from that of the first embodiment in a formation range of the hole non-forming region R. That is, as shown in FIG. 7, the downstream-side boundary line D of the hole non-forming region R of the second embodiment is located on the downstream side of the outer-side swirling flow F2 with respect to the upstream-side boundary line U and on the upstream side of the reference line L.

An angle formed by the upstream-side boundary line U and the downstream-side boundary line D is set in a range of, for example, 15° to 45°, preferably 20° to 40°, and more preferably 25° to 35°.

Accordingly, a range of the hole non-forming region R in the circumferential direction is smaller than that of the first embodiment. On the other hand, the formation range of the outer-peripheral air hole group 54 configuring the outer burner 74 is wider than that of the first embodiment, and a total number of the air holes 50 is also increased. In accordance with the increase in the number of the air holes 50 of the outer-peripheral air hole group 54, the number of the outer-peripheral nozzles 64 is also increased to correspond to the number of the air holes 50, as compared with the first embodiment.

In particular, in the present embodiment, the number of hole groups in a first row on an innermost periphery of the outer-peripheral air hole group 54 configuring the outer burner 74 is increased, as compared with the first embodiment. Among the air holes 50 of the hole group in the first row on the innermost periphery, the air holes 50 that are in contact with the downstream-side boundary line D of the hole non-forming region R overlap with the reference line L, and a part of the air holes 50 enters the upstream side of the outer-side swirling flow F2 with respect to the reference line L.

According to the present embodiment, the number of the air holes 50 configuring the outer-peripheral air hole group 54 of the outer burner 74 and the number of the outer-peripheral nozzles 64 corresponding to the air holes 50 are increased, as compared with the first embodiment. Therefore, it is possible to increase the output of the combustor 3 as a whole, as compared with the first embodiment.

On the other hand, the hole non-forming region R is formed in a range in which the flame transferability from the central burner 71 to the inner burner 73 is the highest. That is, the hole non-forming region R is disposed in a biased manner only in the region on the upstream side of the outer-side swirling flow F2 at the reference line L where the flame is likely to flow in along the central swirling flow F1 of the central burner 71. Therefore, it is possible to increase the output while ensuring the above flame transferability.

### Other Embodiments

Although the embodiments of the present invention have been described hereinbefore, the present invention is not limited thereto and can undergo some changes as appropriate without departing from the technical spirit of the invention.

The upstream-side boundary line U of the hole non-forming region R may not only match the upstream tangential line T1, but may also be present between the upstream tangential line T1 and the reference line L between the central burner 71 and the inner burner 73. Further, the upstream-side boundary line U may be present on the further upstream side of the upstream tangential line T1.

Further, the upstream-side boundary line U may be present on the downstream side of the outer-side swirling flow F2 with respect to the reference line L. The region in which the air holes 50 are not present in the circumferential direction and the radial direction may be present in at least a part of the region between the central burner 71 and the inner burner 73. It is preferable that the range of the region in the circumferential direction has at least a dimension of one air hole 50.

The downstream-side boundary line D of the hole non-forming region R may match, for example, the downstream tangential line T2. That is, the hole non-forming region R may spread over any range between the upstream tangential line T1 and the downstream tangential line T2. Further, the downstream-side boundary line D may be present on the further downstream side of the downstream tangential line T2.

For example, the inner-peripheral air hole group 53 configuring the inner burner 73 may be configured to be formed not only in one row around the outer-side axis line P, but also in a plurality of rows therearound.

The outer-peripheral air hole group 54 configuring the outer burner 74 may be configured to be formed not only in two rows around the outer-side axis line P, but also in one row or three or more rows.

The present invention is not limited to the case where the fuel-air ratio of the central nozzle 61 is higher than the fuel-air ratio of the inner-peripheral nozzle 63 during the rated operation and during a partial load operation, and the above two fuel-air ratios may be the same, or the fuel-air ratio of the inner-peripheral nozzle 63 may be set to be higher than the fuel-air ratio of the central nozzle 61.

Further, the present invention is not limited to the case where the fuel-air ratio of the inner-peripheral nozzle 63 is higher than the fuel-air ratio of the outer-peripheral nozzle 64 during the rated operation and during the partial load operation, and the above two fuel-air ratios may be the same, or the fuel-air ratio of the outer-peripheral nozzle 64 may be set to be higher than the fuel-air ratio of the inner-peripheral nozzle 63. Even in these cases, the inner-peripheral nozzle 63 located on the inner side of the outer-peripheral nozzle 64 still plays a role in maintaining the flame of the outer-peripheral nozzle 64. Further, with the improvement of the flame transferability to the inner-peripheral nozzle 63, it is possible to reduce the fuel supply amount to the inner-peripheral nozzle 63, and thus to lower the combustion temperature.

The processes of the processing performed by the fuel control device 90 described above are stored in a recording medium readable by a computer 200 in a program form, and the computer 200 reads out and executes the program to perform the above pieces of processing. A specific example of the computer 200 will be described below.

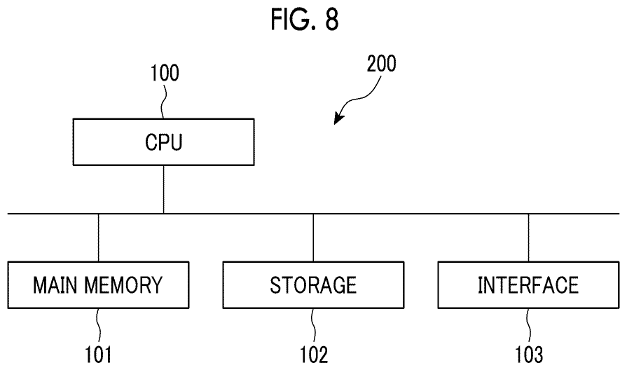

As shown in FIG. 8, the computer 200 includes a CPU 100, a main memory 101, a storage 102, and an interface 103.

For example, the fuel control device 90 described above is mounted on the computer 200. An operation of each processing unit described above is stored in the storage 102 in the program form. The CPU 100 reads out the program from the storage 102, expands the program into the main memory 101, and executes the above processing according to the program. Further, the CPU 100 ensures a storage area in the main memory 101 according to the program.

Examples of the storage 102 include a hard disk drive (HDD), a solid state drive (SSD), a magnetic disk, a magneto-optical disk, a compact disc read only memory (CD-ROM), a digital versatile disc read only memory (DVD-ROM), and a semiconductor memory. The storage 102 may be an internal medium directly connected to a bus of the computer 200 or may be an external medium connected to the computer 200 via the interface 103 or a communication line. In a case where the program is distributed to the computer 200 through the communication line, the computer 200 that receives the distribution may expand the program into the main memory 101 and execute the above processing. The storage 102 is a non-transitory tangible storage medium.

Further, the above program may realize a part of the functions described above. Furthermore, the program may be a so-called differential file (differential program) that can realize the above functions in combination with a program already recorded in the computer 200.

In addition to the above configuration or instead of the above configuration, a custom large scale integrated circuit (LSI) such as a programmable logic device (PLD), an application specific integrated circuit (ASIC), a graphics processing unit (GPU), and a processing device similar thereto may be provided. Examples of the PLD include a programmable array logic (PAL), a generic array logic (GAL), a complex programmable logic device (CPLD), and a field programmable gate array (FPGA). In this case, a part or all of the functions realized by the processor may be realized by the integrated circuit.

### Additional Notes

The combustor 3 and the gas turbine 1 described in each embodiment are understood, for example, as follows.
(1) The combustor 3 according to a first aspect includes an air hole plate 40 that has a plurality of air holes 50 extending in a direction of a combustor axis line O and opening to a downstream end surface 42, and a plurality of fuel nozzles 60 that are provided to correspond to the respective air holes 50 and each supply fuel to the corresponding air hole 50 from an upstream side, in which a central burner 71 is configured of the plurality of air holes 50 and the plurality of fuel nozzles 60 that are collectively disposed to surround the combustor axis line O, an outer-side burner 72 is configured of the plurality of air holes 50 and the plurality of fuel nozzles 60 that are collectively disposed on a radial outer side of the central burner 71, the outer-side burner 72 includes an inner burner 73 that is provided to surround an outer-side axis line P located on a radial outer side of the combustor axis line O, and an outer burner 74 that is provided to surround the inner burner 73, a fuel supply amount to the fuel nozzle 60 is independently adjustable for the inner burner 73 and the outer burner 74, and a hole non-forming region R in which the air holes 50 of the outer burner 74 are not formed is provided between the inner burner 73 and the central burner 71 on the downstream end surface 42.

With the above configuration, it is possible to guide the flame of the central burner 71 to the inner burner 73 of the outer-side burner 72 via the hole non-forming region R. With the transfer of the flame of the central burner 71 to the inner burner 73, it is possible to improve the flame maintainability of the inner burner 73. As a result, it is possible to improve the flame maintainability of the outer burner 74 around the inner burner 73.

Further, since the flame maintainability of the inner burner 73 is ensured, it is possible to suppress the fuel flow rate supplied to the inner burner 73. Accordingly, it is possible to suppress the temperature of the flame of the inner burner 73.
(2) The combustor 3 according to a second aspect is the combustor 3 according to (1), in which the plurality of air holes 50 configuring the central burner 71 have a swirling angle such that a central swirling flow F1 swirling around the combustor axis line O is formed, the plurality of air holes 50 configuring the outer burner 74 have a swirling angle such that an outer-side swirling flow F2 swirling around the outer-side axis line P in a direction opposite to the central swirling flow F1 is formed, and in a case where the downstream end surface 42 is viewed from a downstream side, an upstream-side boundary line U, which extends from the outer-side axis line P in a radial direction of the outer-side axis line P and defines an end portion of the outer-side swirling flow F2 on an upstream side in the hole non-forming region R, is located in a range on an upstream side of a reference line L connecting the combustor axis line O and the outer-side axis line P.

The flame of the central burner 71 is sent in the tangential direction of the outer edge of the central burner 71 along the flow of the central swirling flow F1. Since the hole non-forming region R is disposed to spread to the upstream side of the outer-side swirling flow F2 of the outer-side burner 72 with respect to the reference line, it is possible to guide the flame of the central burner 71 to the inner burner 73 more smoothly.
(3) The combustor 3 according to a third aspect is the combustor 3 according to (2), in which the upstream-side boundary line U is located in a range from the reference line L to a tangential line on the upstream side of the outer-side swirling flow F2 drawn to a circle defining an outer edge of the central burner 71 from the outer-side axis line P.

Accordingly, it is possible to ensure the flame maintainability while the number of air holes is ensured.
(4) The combustor 3 according to a fourth aspect is the combustor 3 according to (2) or (3), in which, in a case where the downstream end surface 42 is viewed from the downstream side, a downstream-side boundary line D, which extends in the radial direction of the outer-side axis line P from the outer-side axis line P and defines an end portion of the outer-side swirling flow F2 on a downstream side in the hole non-forming region R, is located in a range on a downstream side of the reference line L.

Since the hole non-forming region R in which the air holes 50 of the outer burner 74 are not present is widely expanded to the downstream side of the outer-side swirling flow F2 of the outer-side burner 72, it is possible to perform the flame movement from the central burner 71 to the inner burner 73 more reliably.
(5) The combustor 3 according to a fifth aspect is the combustor 3 according to (4), in which the downstream-side boundary line D is located in a range from the reference line L to a tangential line of the outer-side swirling flow F2 on the downstream side drawn to a circle defining an outer edge of the central burner 71 from the outer-side axis line P.

Accordingly, it is possible to ensure the flame maintainability while the number of air holes is ensured.
(6) The combustor according to a sixth aspect is the combustor 3 according to any one of (2) to (5), in which in the hole non-forming region R, a region of the outer-side swirling flow F2 on the upstream side from the reference line L is wider than a region of the outer-side swirling flow F2 on the downstream side from the reference line L.

Accordingly, the large formation region of the outer burner 74 of the outer-side burner 72 is ensured, while the flame transferability from the central burner 71 to the inner burner 73 is improved, and thus it is possible to ensure the output of the combustor 3.
(7) The combustor 3 according to a seventh aspect is the combustor 3 according to (2) or (3), in which, in a case where the downstream end surface 42 is viewed from the downstream side, a downstream-side boundary line D, which extends in the radial direction of the outer-side axis line P from the outer-side axis line P and defines an end portion of the outer-side swirling flow F2 on the downstream side in the hole non-forming region R, is located in a range on the downstream side of the outer-side swirling flow F2 with respect to the upstream-side boundary line U and on the upstream side of the outer-side swirling flow F2 with respect to the reference line L.

Accordingly, the further large formation region of the outer burner 74 of the outer-side burner 72 is ensured, while the flame transferability from the central burner 71 to the inner burner 73 is improved, and thus it is possible to ensure a larger output of the combustor 3.
(8) A gas turbine 1 according to an eighth aspect includes the combustor 3 according to any one of (1) to (8), a compressor 2 that compresses air and supplies the compressed air to the combustor 3, a turbine 4 that is driven by combustion gas generated by the combustor 3, and a fuel control device 90 that controls a fuel supply amount to the fuel nozzle 60 of the combustor 3, in which the fuel control device 90 sets the fuel supply amount such that, at a rated load, a fuel-air ratio of the central burner 71 is higher than a fuel-air ratio of the outer burner 74 and a fuel-air ratio of the inner burner 73 is higher than the fuel-air ratio of the outer burner 74.

Accordingly, it is possible to maintain the flame of the inner burner 73 by the central burner 71 and the flame of the outer burner 74 by the inner burner 73 more reliably.

Further, since the flame is transferred from the central burner 71 without a need to unnecessarily increase the fuel-air ratio of the inner burner 73, it is possible to sufficiently obtain the flame maintainability of the inner burner 73. Therefore, it is possible to maintain the flame of the outer burner 74 by the inner burner 73 reliably, and thus to perform the stable operation while realizing low NOx emission.

### INDUSTRIAL APPLICABILITY With the combustor and the gas turbine of the present disclosure, it is possible to achieve low NOx emission while performing the stable operation.

### REFERENCE SIGNS LIST

1: gas turbine
2: compressor
3: combustor
4: turbine
10: outer cylinder
20: end cover
21: first fuel header
22: second fuel header
23: third fuel header
30: inner cylinder
40: air hole plate
41: upstream end surface
42: downstream end surface
50: air hole
51: central air hole group
52: outer-side air hole group
53: inner-peripheral air hole group
54: outer-peripheral air hole group
60: fuel nozzle
61: central nozzle
62: outer-side nozzle
63: inner-peripheral nozzle
64: outer-peripheral nozzle
71: central burner
72: outer-side burner
73: inner burner
74: outer burner
80: fuel supply system
81: first fuel line
81a: first fuel regulating valve
82: second fuel line
82a: second fuel regulating valve
83: third fuel line
83a: third fuel regulating valve
90: fuel control device
91: output request acquisition unit
92: fuel distribution setting unit
93: regulating valve control unit
100: CPU
101: main memory
102: storage
103: interface
200: computer
O: combustor axis line
P: outer-side axis line
L: reference line
U: upstream-side boundary line
D: downstream-side boundary line
R: hole non-forming region
F1: central swirling flow
F2: outer-side swirling flow
T1: upstream tangential line
T2: downstream tangential line

1. A combustor comprising:
an air hole plate that has a plurality of air holes extending in a direction of a combustor axis line and opening to a downstream end surface; and
a plurality of fuel nozzles that are provided to correspond to the respective air holes and each supply fuel to the corresponding air hole from an upstream side,
wherein a central burner is configured of the plurality of air holes and the plurality of fuel nozzles that are collectively disposed to surround the combustor axis line,
an outer-side burner is configured of the plurality of air holes and the plurality of fuel nozzles that are collectively disposed on a radial outer side of the central burner,
the outer-side burner includes
an inner burner that is provided to surround an outer-side axis line located on a radial outer side of the combustor axis line, and
an outer burner that is provided to surround the inner burner,
a fuel supply amount to the fuel nozzle is independently adjustable for the inner burner and the outer burner, and
a hole non-forming region in which the air holes of the outer burner are not formed is provided between the inner burner and the central burner on the downstream end surface.

2. The combustor according to claim 1,
wherein the plurality of air holes configuring the central burner have a swirling angle such that a central swirling flow swirling around the combustor axis line is formed,
the plurality of air holes configuring the outer burner have a swirling angle such that an outer-side swirling flow swirling around the outer-side axis line in a direction opposite to the central swirling flow is formed, and
in a case where the downstream end surface is viewed from a downstream side, an upstream-side boundary line, which extends from the outer-side axis line in a radial direction of the outer-side axis line and defines an end portion of the outer-side swirling flow on an upstream side in the hole non-forming region, is located in a range on an upstream side of a reference line connecting the combustor axis line and the outer-side axis line.

3. The combustor according to claim 2,
wherein the upstream-side boundary line is located in a range from the reference line to a tangential line on the upstream side of the outer-side swirling flow drawn to a circle defining an outer edge of the central burner from the outer-side axis line.

4. The combustor according to claim 2,
wherein, in a case where the downstream end surface is viewed from the downstream side, a downstream-side boundary line, which extends in the radial direction of the outer-side axis line from the outer-side axis line and defines an end portion of the outer-side swirling flow on a downstream side in the hole non-forming region, is located in a range on a downstream side of the reference line.

5. The combustor according to claim 4,
wherein the downstream-side boundary line is located in a range from the reference line to a tangential line of the outer-side swirling flow on the downstream side drawn to a circle defining an outer edge of the central burner from the outer-side axis line.

6. The combustor according to claim 4,
wherein in the hole non-forming region, a region of the outer-side swirling flow on the upstream side from the reference line is wider than a region of the outer-side swirling flow on the downstream side from the reference line.

7. The combustor according to claim 2,
wherein, in a case where the downstream end surface is viewed from the downstream side, a downstream-side boundary line, which extends in the radial direction of the outer-side axis line from the outer-side axis line and defines an end portion of the outer-side swirling flow on the downstream side in the hole non-forming region, is located in a range on the downstream side of the outer-side swirling flow with respect to the upstream-side boundary line and on the upstream side of the outer-side swirling flow with respect to the reference line.

8. A gas turbine comprising:
the combustor according to claim 1;
a compressor that compresses air and supplies the compressed air to the combustor;
a turbine that is driven by combustion gas generated by the combustor; and
a fuel control device that controls a fuel supply amount to the fuel nozzle of the combustor,
wherein the fuel control device sets the fuel supply amount such that, at a rated load, a fuel-air ratio of the central burner is higher than a fuel-air ratio of the outer burner and a fuel-air ratio of the inner burner is higher than the fuel-air ratio of the outer burner.
